(19) United States
(12) Patent Application Publication
(10) Pub. No.: US 2007/0160927 A1
(43) Pub. Date: Jul. 12, 2007

(54) Radiation-sensitive resin composition, process for producing the same and process for producing semiconductor device therewith

(76) Inventors: Kenichi Murakami, Mie (JP); Suguru Sassa, Fukushima (JP); Katsuhiro Yoshikawa, Shizuoka (JP); Masato Nishikawa, Shizuoka (JP); Ken Kimura, Shizuoka (JP); Yoshiaki Kinoshita, Shizuoka (JP)

Correspondence Address: MCDERMOTT WILL & EMERY LLP, 600 13TH STREET, N.W., WASHINGTON, DC, 20005-3096, US

(21) Appl. No.: 10/544,902

(22) PCT Filed: Feb. 5, 2004
(86) PCT No.: PCT/JP04/01203

§ 371 Date: May 11, 2006

(30) Foreign Application Priority Data
Feb. 10, 2003 (JP) 2003-032339

(51) Int. Cl. G03C 1/00

(52) U.S. Cl. 430/270.1

(57) ABSTRACT

A chemically amplified radiation sensitive resin composition comprising at least (1) a base resin that is an alkali-soluble resin or an alkali-insoluble or slightly alkali-soluble resin protected by an acid dissociable protecting group wherein the amount of an ultrahigh molecular weight component whose weight average molecular weight determined by polystyrene standards as measured by gel permeation chromatography with multi angle laser light scattering method is one million or more is 1 ppm or less, (2) a photo-acid generator capable of generating an acid by irradiation of radiation, and (3) a solvent.

This radiation sensitive resin composition is applied onto an object to be processed 2 to form a photoresist film 3. The photoresist film is exposed and then developed to form a fine resist pattern 4 with 0.2 μm or less in pattern width. Thereafter, dry etching is conducted to form a gate electrode, hole shape patterning or grooved shape patterning of a semiconductor device. In this manner, patterning with minimized occurrence of pattern defects such as microbridge can be realized.

### TECHNICAL FIELD

The present invention relates to a chemically amplified radiation sensitive resin composition, that can be used as a photoresist properly in a fine processing upon manufacturing electronic parts such as a semiconductor or three-dimensional micro structural articles such as a micro-machine, a process for producing the same and a process for producing a semiconductor device therewith.

### BACKGROUND ART

In a fine processing upon manufacturing electronic parts such as a semiconductor and three-dimensional micro structural articles, a photo-lithographic method is being employed generally. In the photo-lithographic method, a positive or negative-working radiation sensitive resin composition is used in order to form a resist pattern. In these radiation sensitive resin compositions, a radiation sensitive resin composition comprising, for example, an alkali-soluble resin and a quinonediazide compound that is a photosensitive agent is widely used as a positive-working photoresist.

In recent years, along with the tendencies which induce high degree of integration and high process-speed of LSI, a micronization, wherein the design rule is a quarter-micron or further finer is being required in the field of manufacturing microelectronic devises. In order to respond to further fining of a design rule, light sources so far applied such as a visible light or a near-ultraviolet light (wavelength; 400 to 300 nm) are not enough as an exposure light source, and it is getting necessary to use a deep ultraviolet ray such as KrF excimer laser (248 nm), ArF excimer laser (193 nm), F₂ excimer laser (153 nm), and so on or further shorter wavelength radiation such as X-rays and electron beams. A lithographic process using these light sources, therefore, has been proposed and has been coming into practice. In order to respond to the further fining of a design rule, higher resolution is being required for a radiation sensitive resin composition that is used as a photoresist upon fine processing. Further, besides high resolution, an improvement of performance such as sensitivity and accuracy of image dimension are being required to a radiation sensitive resin composition in the same time. As a radiation sensitive resin composition that is sensitive to the radiation with short wavelength and satisfies these requirements, “a chemically amplified radiation sensitive resin composition” was proposed. This chemically amplified radiation sensitive resin composition contains photo-acid generator that generates an acid by irradiation of radiation. And an image-formation is made by the catalytic action of the generated acid from this photo-acid generating compound by irradiation of radiation. As the chemically amplified radiation sensitive resin composition has an advantage that high sensitivity is obtained by the catalytic action of the acid, the radiation sensitive resin composition so far applied is being replaced by the chemically amplified radiation sensitive resin composition and the chemically amplified radiation sensitive resin composition is being used.

The chemically amplified radiation sensitive resin composition has a positive type and a negative type in the same way as the radiation sensitive resin composition so far applied. As a positive-working chemically amplified radiation sensitive resin composition, two-component system comprising a base resin and a photo-acid generator and three component system comprising a base resin, a photo-acid generator, and a dissolution inhibitor having an acid dissociable group are known. And as the positive-working chemically amplified radiation sensitive resin composition, a lot of radiation sensitive resin compositions comprising a base resin which is made a basis with polyhydroxystyrene resin and so on were reported. As this base resin which is made a basis with polyhydroxystyrene resin, there are reported resins whose phenolic hydroxyl group is protected partially or totally with a t-butoxycarbonyl group (U.S. Pat. No. 4,491,628 and U.S. Pat. No. 5,403,695 to be referred, for example), a t-butyl group, a trimethylsilyl group and a tetrahydropyranyl group (U.S. Pat. No. 5,350,660 to be referred, for example), and a 2-(alkoxyethyl) group (U.S. Pat. No. 5,468,589 to be referred, for example) which are acid-cleavable protecting groups, or the mixture thereof. Resins which are a copolymer or a terpolymer comprising a hydroxystyrene and an acrylic acid or a methacrylic acid and whose carboxylic acid is partially or totally protected with an acid-cleavable protecting group, for example a t-butyl group (U.S. Pat. No. 4,491,628 and U.S. Pat. No. 5,482,816 to be referred, for example), an amyl group, a tetrahydropyranyl group and so on were reported as a useful one. Further, in Japanese Patent publication Laid-open No. Hei 11-125907, as an acid dissociable group of an acid dissociable group-containing resin in a chemically amplified positive-working resist, a t-butyl group, a t-butoxycarbonylmethyl group, a t-butoxycarbonyl group, a 1-methoxyethyl group, a 1-ethoxyethyl group, and so on were also reported.

Further as a polymer for a positive-working chemically amplified resist for an exposure to ArF excimer laser, it is known that a polymer having an alicyclic ring is preferable from the view point of transmittance of ArF excimer laser and a dry etching resistance. These alicyclic rings can be exemplified with bornane-ring, norbornane-ring, tricyclodecane-ring, tetracyclodecane-ring, adamantane-ring, and so on. As a concrete polymer, ones having polymerization unit derived from alicyclic ester of (meth)acrylic acid, ones having polymerization unit derived from vinyl ester or isopropenyl ester of alicyclic carboxylic acid, and so on (D. C. Hofer, et al., Journal of Photopolymer Science and Technology, Vol. 9, No. 3 (1996), Page 387-398 to be referred, for example), a polymer having an alicyclic group in an acid dissociable group (S. Iwasa, et al., Journal of Photopolymer Science and Technology, Vol. 9, No. 3 (1996), Page 447-456 to be referred, for example), a polymer containing an alternative copolymer structure of 2-norbornene and maleic anhydride (T. I. Wallow, et al., Proc. SPIE 1996, 2724, 355-364 to be referred, for example), and so on are raised.

Besides them, a polymer of a monomer having an alicyclic structure such as norbornene-ring in a main chain (monomer 1) or of maleic anhydride or a vinyl monomer having a carboxyl group (monomer 2) (Japanese patent Publication Laid-Open No. Hei 10-10739 to be referred, for example), a copolymer of the monomers described before and acrylate or methacrylate protected with a protecting group as a third monomer, a polymer of acrylic ester having an adamantane frame in an ester part (Japanese patent Publication Laid-Open No. Hei 4-39665 to be referred, for example), a copolymer of acrylic ester having an adamantane frame and methacrylic acid or mevalonic lactone-methacrylate and so on (Japanese patent Publication Laid-Open No. 2000-338676 to be referred, for example), further a polymer having polyvinyl phenol ester of telebinic acid as a recurring unit having heterocyclic group containing oxygen such as γ-butylolactone in a side chain and so on (Japanese patent Publication Laid-Open No. Hei 7-181677 to be referred, for example), and so on can be raised.

Furthermore, as a polymer for a chemically amplified resist for an exposure to F₂ excimer laser, there have been so far known a various kind of favorable polymers such as a fluorine-containing polymer and so on. Those polymers can be exemplified with a high molecular weight compound having a recurring unit of an alkyl group containing at least one fluorine atom (Japanese patent Publication Laid-Open No. 2001-174997 to be referred, for example), phenol resin, wherein a phenolic hydroxyl group is partially substituted with an acid unstable group and the phenolic nucleus is substituted with a fluorine atom or a trifluoromethyl group (Japanese patent Publication Laid-Open No. 2001-163945 to be referred, for example), polyvinyl alcohol species, wherein at least one carbon atom in a main chain is substituted with a fluorine atom or a trifluoromethyl group and a hydroxyl group may be partially substituted with an acid-unstable group (Japanese patent Publication Laid-Open No. 2001-133979 to be referred, for example), a high molecular weight compound having an ester between a fluorinated acrylic acid and a silanized alkylenealcohol having a fluorinated alkyl group as a recurring unit (Japanese patent Publication Laid-Open No. 2001-226432 to be referred, for example), a polymer wherein an ester group having a fluorine-containing aromatic ring is introduced into an acid dissociable unit in a base polymer (Japanese patent Publication Laid-Open No. 2002-249520 to be referred, for example), a high molecular weight compound comprising two species of fluorinated acrylic derivatives protected with two kinds of different acid-unstable group and fluorinated vinyl containing a linear, branched or cyclic monovalent hydrocarbon group of carbon numbers 1 to 20 or a fluorinated monovalent hydrocarbon group as an ether unit (Japanese patent Publication Laid-Open No. 2002-293840 to be referred, for example), polysiloxane wherein a carboxyl group or a cyano group protected with an acid-unstable group is bonded with a divalent or (C+1)-valent (C is an integer of 1 to 4) cyclic hydrocarbon group of carbon numbers 3 to 20 (Japanese patent Publication Laid-Open No. 2002-332353 to be referred, for example), a fluorine group-containing resin having a structure substituted with a fluorine atom in a main or side chain of a polymer backbone and having a group which can accelerate a solubility in alkali-developer by decomposition by the action of acid (Japanese patent Publication Laid-Open No. 2002-333715 to be referred, for example), polysiloxane wherein an aryl group substituted with a fluorine atom is bonded directly or through a hydrocarbon group having carbon numbers 1 to 10 (Japanese patent Publication Laid-Open No. 2002-338690 to be referred, for example), and so on can be raised.

As polymers for a chemically amplified type resist for electron beam irradiation, the resin containing a monomer unit represented by the general formula (1): 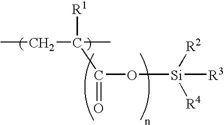
wherein R¹ represents a hydrogen atom, a fluorine atom, a chlorine atom, an alkyl group or a silyl group, R², R³ and R⁴ represent a fluorine atom, a chlorine atom, an alkyl group or an alkoxyl group, and n is 0 or 1, for example (Japanese patent Publication Laid-Open No. 2001-22073 to be referred, for example), a copolymerized resin of p-hydroxystyrene or its derivative wherein a hydroxyl group of the p-hydroxystyrene or a carboxyl group of a monomer to be copolymerized is protected with an acetoxy group, a t-butyl group, a tetrahydropyranyl group, a methyladamatyl group, and so on (Japanese patent Publication Laid-Open No. 2001-27806 to be referred, for example), a resin containing at least one monomer unit selected from the general formula (2): 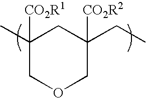
wherein R¹ and R² represent a hydrogen atom, an alkyl group or an acid-removable protecting group or the general formula (3): 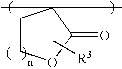
wherein R³ represents one or two or more of hydrogen atoms, alkyl groups or acid-removable protecting groups and n is an integer from 0 to 4 (Japanese patent Publication Laid-Open No. 2001-81139 to be referred, for example.) or a resin containing a tertiary ester alicyclic group having at least a molecular volume of approximately 125 cubic Å, a photoacid-labile ester group and a phenolic recurring unit (Japanese patent Publication Laid-Open No. 2001-194792 to be referred), and so on are raised. These polymers for chemically amplified type resist for electron beam irradiation are also used as a resin for chemically amplified type resist for deep ultra-violet ray irradiation favorably and suitably.

On the other hand, as a chemically amplified negative-working radiation sensitive resin composition, one comprising a base resin, a photo-acid generator and a crosslinking agent, one comprising a combination of a crosslinking agent such as hexamethoxy methyl melamine and alkali-soluble phenolic resin, and so on were reported (U.S. Pat. No. 5,376,504 and U.S. Pat. No. 5,389,491 to be referred, for example). As an alkali-soluble phenolic resin which is suitable for a negative-working chemically amplified resist, a novolak type of phenol resin, polyvinyl phenol resin whose molecular weight distribution was narrowed, phenol resin which was converted to a cyclic alcohol structure partially by hydrogenation, polyvinyl phenol resin whose hydroxyl group was partially protected with an alkyl group, polyvinyl phenol resin having an acid-inactive protecting group such as an acyl group and so on, polyvinyl phenol resin which was copolymerized with styrene or (meth)acrylate, a various kind of alkali-soluble resins which are crosslinked by a crosslinking agent such as a carboxyl group-containing resin are known. These resins are used as a base resin for a negative-working chemically amplified resist for ultra-violet ray, deep ultra-violet ray, electron beam or X-ray irradiation (Japanese patent Publication Laid-Open No. 2001-337452 to be referred, for example). As a base resin for a negative-working chemically amplified resist for electron beam or X-ray irradiation, a resin containing p-hydroxystyrene having, for example, a hydroxyl group on para-position and an alkoxyl group on ortho-position as a monomer unit (Japanese patent Publication Laid-Open No. 2001-114825 to be referred, for example), an alkali-soluble resin containing a structure unit represented by the general formula (4): 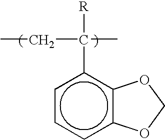
wherein R represents a hydrogen atom or a methyl group (Japanese patent Publication Laid-Open No. 2001-174994 to be referred, for example), an alkali-soluble resin containing a recurring unit having a benzene ring, a biphenyl ring, a terphenyl ring or a condensed ring such as a naphthalene ring, an anthracene ring and so on in a side chain, those rings of which were replaced with a phenolic hydroxyl group or an alkoxyl group (Japanese patent Publication Laid-Open No. 2001-174995 to be referred, for example), an alkali-soluble resin such as polyvinyl phenol or hydrogenated polyvinyl phenol, a phenolic hydroxyl group of which was partially alkyl-etherified, aryl-etherified, or alkenyl-etherified (Japanese patent Publication Laid-Open No. 2001-242625 to be referred, for example), an alkali-soluble resin containing a recurring unit represented by the general formula (5): 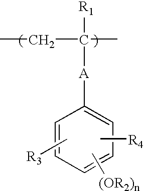
wherein R₁ represents a hydrogen atom and so on, R₂, R₃ and R₄ represent a hydrogen atom, an alkyl group which may have a substituting group, A represents a bonding such as a single bond, alkylene, —O—, —SO₂—, —COOR—, —OCOR—, and —CONHR— (R represents a single bond or a linkage group.) and n is an integer from 1 to 3 (Japanese patent Publication Laid-Open No. 2001-337452 to be referred, for example) are raised.

As a photo-acid generator which is used for a positive- or negative-working chemically amplified photoresist, ionic onium salt, particularly hexafluoro antimonate, trifluoromethane sulphonate (U.S. Pat. No. 5,569,784 to be referred, for example), or iodonium salt or sulphonium salt (U.S. Pat. No. 4,058,400 and U.S. Pat. No. 4,933,377 to be referred, for example) with a strong non-nucleophilic anion such as aliphatic/aromatic sulphonate (U.S. Pat. No. 5,624,787 to be referred, for example), and so on were reported. And also it was proposed that a photo-acid generator that generates some kind of halogenated hydrogen was effective for a negative-working photoresist (U.S. Pat. No. 5,599,949 to be referred, for example). Further, it was also proposed to use a photo-acid generator composed of “a compound that generates a carboxylic acid with boiling point of 150° C. or higher by irradiation of radiation” and “a compound that generates an acid other than a carboxylic acid” (Japanese Patent Publication Laid-open No. Hei 11-125907 to be referred, for example).

In this way, a lot of improvements have been conducted for a chemically amplified radiation sensitive resin composition in view points of a basic resin, a photo-acid generator, a crosslinking agent, and so on and such compositions have been used practically.

However, as the degree of integration of the integrated circuits for a semiconductor devise is getting higher year by year, higher resolution is required as it is getting so. Pattern defects, therefore, have been becoming a big problem including an occurrence of micro bridge which is thought to be generated by the phenomenon that a resist between one pattern and another pattern is not removed and remains particularly in a fine pattern below a quarter micron upon developing. If those pattern defects generates, not only a pattern in accordance with a design cannot be obtained, but also a pattern form that can be provided with a practical use cannot be obtained. Therefore the pattern defects often cause a low yield in a process for producing such as a semiconductor and are becoming an important theme to be solved.

The above-described problem of pattern defects is the problem that has become obvious in the recent micronization, particularly in the pattern formation below 0.2 μm and it is the fact that there has been so far no measure to solve these themes.

Referring to the above-described situation, an object of the present invention is to offer a chemically amplified radiation sensitive resin composition, which is excellent in a pattern form, a process latitude and a process stability as well as has a good sensitivity and a resolution in a chemically amplified photoresist used for producing a semiconductor and so on, particularly which has less pattern defects such as a micro bridge and so on in a fine pattern; its producing process; and a process for producing semiconductor device therewith.

### DISCLOSURE OF THE INVENTION

As a result of eager study and examination, the inventors of the invention found that in the chemically amplified radiation sensitive resin composition which is useful as a photoresist upon a process for producing a semiconductor device and so on, the above described object is attained by that

(a) a content of an ultrahigh molecular weight component with one million or higher of a weight average molecular weight as determined by polystyrene standards, which is measured by a gel permeation chromatography (GPC) method using a Multi Angle Laser Light Scattering (hereafter it may be called as “MALS”) detector, e.g. a gel permeation chromatography with a Multi Angle Laser Light Scattering method (MALS method) is made below the determined amount in the composition,

(b) the chemically amplified radiation sensitive resin composition described in the item (a) above is formed by using, as the base resin composing the chemically amplified radiation sensitive resin composition, a resin wherein a content of an ultrahigh molecular weight component having one million or higher of a weight average molecular weight as determined by polystyrene standards which is measured according to above described method is lower than the determined amount,

(c) the chemically amplified radiation sensitive resin composition described in the item (a) above is formed by using an alkali-insoluble or slightly alkali-soluble resin protected by an acid dissociable protecting group as a base resin which was prepared using a resin wherein a content of an ultrahigh molecular weight component having one million or higher of a weight average molecular weight as determined by polystyrene standards which is measured according to above described method as an alkali-soluble resin that is a raw material of the base resin, or

(d) the amount of an ultrahigh molecular weight component in a base resin or a raw material of a base resin is measured by a gel permeation chromatography (GPC) method with MALS method, then the resin wherein the amount of an ultrahigh molecular weight component is below the determined amount is selected, and the selected resin is used as a base resin or a raw material of a base resin,

and reached the present invention.

It means, the present invention relates to a chemically amplified radiation sensitive resin composition which is characterized in that in the chemically amplified radiation sensitive resin composition comprising at least (1) a base resin which is an alkali-soluble resin or an alkali-insoluble or slightly alkali-soluble resin protected by an acid dissociable protecting group, (2) a photo-acid generator generating an acid by irradiation of radiation, and (3) a solvent, the amount of an ultrahigh molecular weight component in the above described alkali-soluble resin or alkali-insoluble or slightly alkali-soluble resin protected by an acid dissociable protecting group as measured by a gel permeation chromatography (GPC) method with MALS method in the chemically amplified radiation sensitive resin composition is 0.2 ppm or less.

Further the present invention relates to a chemically amplified radiation sensitive resin composition which is characterized in that in the above-described chemically amplified radiation sensitive resin composition, the amount of an ultrahigh molecular weight component having one million or more of the weight average molecular weight as determined by polystyrene standards when measured by a gel permeation chromatography (GPC) method with a MALS method in the above described base resin or an alkali-soluble resin before being protected with an acid dissociable protecting group is 1 ppm or less.

Furthermore the present invention relates to a process for producing a chemically amplified radiation sensitive resin composition comprising a step of measuring a content of an ultrahigh molecular weight component having one million or more of the weight average molecular weight as determined by polystyrene standards by a gel permeation chromatography with a MALS method and removing the component in the process for producing the above-described chemically amplified radiation sensitive resin composition.

And also the present invention relates to a process for producing a semiconductor device, comprising the steps of:

applying a chemically amplified radiation sensitive resin composition on an object to be processed to form a photoresist film and then processing the photoresist film into a desired form; and

etching the object to be processed by using as a mask a photoresist pattern obtained in the above step,

wherein a chemically amplified radiation sensitive resin composition that forms the photoresist film comprises at least (1) a base resin that is an alkali-soluble resin or an alkali-insoluble or slightly alkali-soluble resin protected by an acid dissociable protecting group, (2) a photo-acid generator that generates an acid by irradiation of radiation, and (3) a solvent, and a content of an ultrahigh molecular weight component having one million or more of the weight average molecular weight as determined by polystyrene standards of the alkali-soluble resin or the alkali-insoluble or slightly alkali-soluble resin protected by an acid dissociable protecting group in the composition is 0.2 ppm or less when measured by a gel permeation chromatography (GPC) with a MALS method.

And also the present invention relates to the process for producing a semiconductor device described above, wherein the amount of an ultrahigh molecular weight component having one million or more of the weight average molecular weight as determined by polystyrene standards in above described base resin or an alkali-soluble resin before being protected with an acid dissociable protecting group is 1 ppm or less when measured by a gel permeation chromatography (GPC) method with a MALS method.

### BRIEF EXPLANATION OF DRAWINGS

FIG. 1 is outlined cross sections showing an example of forming a pattern with concavity shape by applying the chemically amplified radiation sensitive resin composition of the present invention.

FIG. 2 is outlined cross sections showing an example of forming a pattern with convexity shape by applying the present invention.

FIG. 3 is a drawing showing a top surface-observing SEM photograph of a pattern without defects.

FIG. 4 is a drawing showing Tilt-SEM photograph of a pattern with a micro bridge, which is a pattern defect.

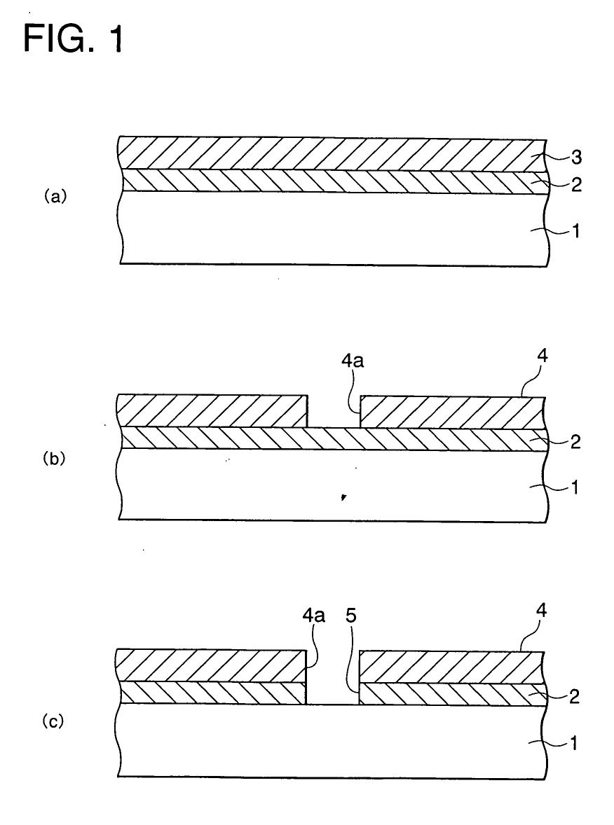

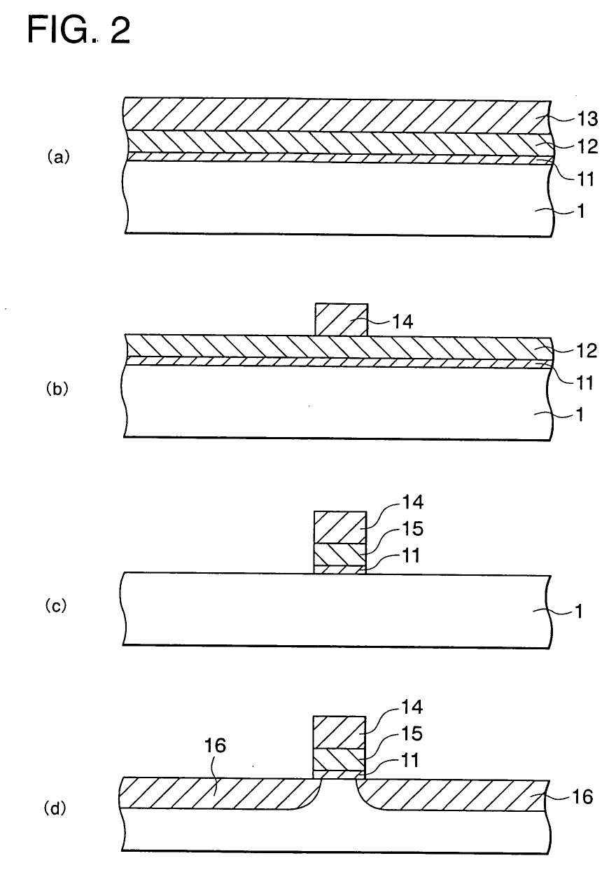

In the FIGS. 1 and 2, sign 1 represents a silicon semiconductor substrate, sign 2 represents an object to be processed, signs 3 and 13 represent a photoresist film, signs 4 and 14 represent a resist mask, sign 4a represents a pattern of grooved shape, sign 5 represents a groove, sign 11 represents a gate dielectric film, sign 12 represents a polycrystalline silicon film, sign 15 represents a gate electrode, sign 16 represents a source or drain.

### DETAILED EXPLANATION OF THE INVENTION

The present invention will be explained further in details in the following.

In the chemically amplified radiation sensitive resin composition of the present invention, an alkali-soluble resin or an alkali-insoluble or slightly alkali-soluble resin protected by an acid dissociable protecting group, which is made alkali-soluble when the acid dissociable protecting group is dissociated is used as a base resin. As these base resins, including the chemically amplified radiation sensitive resin compositions which were already exemplified as prior art in the present specification, any of alkali-soluble resins or alkali-insoluble or slightly alkali-soluble resins protected by an acid dissociable protecting group which are used so far as a base resin in the chemically amplified radiation sensitive resin composition can be used.

Of these base resins, as an alkali-insoluble or slightly alkali-soluble resin protected with an acid dissociable protecting group which is used in the positive-working chemically amplified radiation sensitive resin, ones wherein an alkali-soluble resin is partially protected with an acid dissociable protecting group can be raised, for example. These alkali-insoluble or slightly alkali-soluble resins wherein an alkali-soluble group of the alkali-soluble resin is partially protected with an acid dissociable protecting group can be exemplified, as representative examples, with (i) a reaction product between (a) a homopolymer of hydroxystyrenes, a copolymer of hydroxystyrenes and other monomer, or a phenol resin and (b) vinyl ether compound or dialkyldicarbonate (Carbon number of the alkyl group is 1 to 5.), (ii) a homopolymer of a reaction product between hydroxystyrenes and a vinyl ether compound or dialkyldicarbonate (Carbon number of the alkyl group is 1 to 5.) or a copolymer between the reaction product and other monomer, or (iii) resins wherein a part of protecting group in such homopolymer or copolymer having these groups protected with a protecting group is dissociated by an acid, if necessary.

As hydroxystyrenes, which are used for preparing these polymers, 4-hydroxystyrene, 3-hydroxystyrene and 2-hydroxystyrene are preferable. These 4-hydroxystyrene, 3-hydroxystyrene and 2-hydroxystyrene can be made alkali-insoluble resins by introduction a protecting group to poly(4-hydroxystyrene), poly(3-hydroxystyrene) or poly(2-hydroxystyrene) produced by homopolymerization or a copolymer, a terpolymer or the like produced by polymerization of 4-, 3- or 2-hydroxystyrene and other monomers; or by copolymerization of 4-, 3- or 2-hydroxystyrene protected by the protecting group with other monomers, as described above. Furthermore alkali-insoluble or slightly alkali-soluble resins may be prepared by dissociating a part of protecting groups in the alkali-insoluble resins having a protecting group which are prepared by above described methods with an acid.

Other monomers which are used for preparing the above described copolymers and copolymerized with hydroxystyrenes can be exemplified with styrene, 4-, 3- or 2-acetoxystyrene, 4-, 3- or 2-alkoxystyrene, α-methylstyrene, 4-, 3- or 2-alkylstyrene, 3-alkyl-4-hydroxystyrene, 3,5-dialkyl-4-hydroxystyrene, 4-, 3- or 2-chlorostyrene, 3-chloro-4-hydroxystyrene, 3,5-dichloro-4-hydroxystyrene, 3-bromo-4-hydroxystyrene, 3,5-dibromo-4-hydroxystyrene, vinylbenzylchloride, 2-vinylnaphthalene, vinylanthracene, vinylaniline, vinylbenzoic acid, vinylbenzoic esters, N-vinylpyrrolidone, 1-vinylimidazol, 4- or 2-vinylpyridine, 1-vinyl-2-pyrrolidone, N-vinyllactam, 9-vinylcarbazol, acrylic acid, acrylic ester and derivatives thereof, methacrylic acid, methacrylic ester and derivatives thereof such as methyl methacrylate and derivatives thereof, methacrylamide and derivatives thereof, acrylonitrile, methacrylonitrile, 4-vinylphenoxyacetic acid and derivatives thereof such as 4-vinylphnoxyacetic esters, maleimide and derivatives thereof, N-hydroxymaleimide and derivatives thereof, maleic anhydride, maleic acid or fumaric acid and derivatives thereof such as maleic or fumaric ester, vinyltrimethylsilane, vinyltrimethoxysilane, or vinylnorbornene and derivatives thereof, for example.

Further, favorable other monomers can be exemplified with isopropenylphenol, propenylphenol, (4-hydroxyphenyl)-acrylate or methacrylate, (3-hydroxyphenyl)-acrylate or methacrylate, (2-hydroxyphenyl)-acrylate or methacrylate, N-(4-hydroxyphenyl)-acrylamide or methacrylamide, N-(3-hydroxyphenyl)-acrylamide or methacrylamide, N-(2-hydroxyphenyl)-acrylamide or methacrylamide, N-(4-hydroxybenzyl)-acrylamide or methacrylamide, N-(3-hydroxybenzyl)-acrylamide or methacrylamide, N-(2-hydroxybenzyl)-acrylamide or methacrylamide, 3-(2-hydroxy-hexafluoropropyl-2)-styrene, 4-(2-hydroxy-hexafluoropropyl-2)-styrene, for example.

As an alkali-soluble resin before being protected with an acid dissociable protecting group, not only a homopolymer of hydroxystyrenes or a copolymer of these monomers and other monomers or phenol resin but also a homopolymer of vinyl monomer having a phenolic hydroxyl group or a carboxyl group in a side chain or as a side chain or a copolymer of these monomers and vinyl monomer having neither a phenolic hydroxyl group nor a carboxyl group in a side chain may be used.

Vinyl ether compounds, which modify a group to provide with an alkali-solubility to form an acid dissociable protecting group, can be exemplified with n-butylvinyl ether, t-butylvinyl ether, and so on. These vinyl ether compounds can be used singly or in a mixture of two or more kinds thereof.

Dialkyl carbonates, which modify a group to provide with an alkali-solubility to form an acid dissociable protecting group, can be exemplified with di-t-butyl carbonate as a favorable compound.

Including examples exemplified above, acid dissociable protecting groups can be exemplified with a group, tertiary carbon of which bonds with an oxygen atom such as tert-butyl, tert-butoxycarbonyl and tert-butoxycarbonylmethyl; a group of acetal type such as tetrahydro-2-pyranyl, tetrahydro-2-furyl, 1-methoxyethyl, 1-ethoxyethyl, 1-(2-methylpropoxy)ethyl, 1-(2-methoxyethoxy)ethyl, 1-(2-acetoxyethoxy)ethyl, 1-[2-(1-adamantyloxy)ethoxy]ethyl, and 1-[2-(1-adamantanecarbonyloxy)ethoxy]ethyl; a remaining group of non-aromatic cyclic compounds such as 3-oxocyclohexyl, 4-methyltetrahydro-2-pyron-4-yl and 2-methyl-2-adamantyl. These are just examples of an acid dissociable protecting group and the resin containing an acid dissociable protecting group used in the present invention is not limited with these examples.

As an alkali-soluble resin that is used in the chemically amplified radiation sensitive resin composition of the present invention, the similar one to alkali-soluble resins before being protected with an acid dissociable protecting group can be raised as a favorable one.

Concerning to an alkali-soluble resin used as a base resin, an alkali-insoluble or slightly alkali-soluble resin which is protected with an acid dissociable protecting group, and alkali-soluble resin which is a raw material for preparing an alkali-insoluble or slightly alkali-soluble resin protected with an acid dissociable protecting group, it is not necessary that the amount of an ultrahigh molecular weight component having the weight average molecular weight as determined by polystyrene standards of one million or more which is detected by a multi angle laser light scattering detector is not always to be 1 ppm or less in the resin component. However the amount is preferably 1 ppm or less, more preferably 0.1 ppm or less, further preferably 0.01 ppm or less. The resins having such favorable properties can be obtained from alkali-soluble resins and alkali-insoluble or slightly alkali-soluble resins, a group providing with alkali-solubility of which is partially protected with an acid-cleavable protecting group, so far applied in the chemically amplified resin by measuring an amount of an ultrahigh molecular weight component having the weight average molecular weight of one million or more as determined by polystyrene standards when measured by a gel permeation chromatography (GPC) using a MALS detector in the resin and then selecting resins having the above described amount of ultrahigh molecular weight component in the resin. In addition, the resins having such favorable properties can be also obtained by treating the above-described resins by using the publicly known ways such as a solvent extraction method, a separation method by filtration, a solvent cleaning method, and so on, measuring in the resin the content of an ultrahigh molecular weight component having the weight average molecular weight of one million or more as determined by polystyrene standards when measured by a gel permeation chromatography (GPC) with a MALS method, and then selecting a resin containing ultrahigh molecular weight component below the determined amount.

On the other hand, photo-acid generators are the compounds which can generate an acid by irradiation of radiation and are exemplified with an onium salt, a halogen containing compound, a diazomethane compound, a sulfone compound, a sulfonic acid compound and any other compounds which are so far applied for a photo-acid generator in a chemically amplified radiation sensitive resin composition. As a favorable photo-acid generator, onium salts such as iodonium salt, sulfonium salt, diazonium salt, ammonium salt or pyridinium salt with a triflate or a hexaflate; halogen containing compounds such as a haloalkyl group-containing hydrocarbon compound or a haloalkyl group-containing heterocyclic compound, for example (trichloromethyl)-s-triazine derivatives such as phenyl-bis(trichloromethyl)-s-triazine and methoxyphenyl-bis(trichloromethyl)-s-triazine; bromated compounds such as tribromoneopentyl alcohol and hexabromohexane; iodinated compounds such as hexaiodohexane and so on can be raised.

And as a diazomethane compound, there can be exemplified bis(trifluoromethylsulfonium)diazomethane, bis(cyclohexyl-sulfonium)diazomethane, and so on. As a sulfonium compound, there can be exemplified β-ketosulfone, β-sulfonyl sulfone and so on. As a slfonic acid compound, there can be exemplified alkyl(C₁₋₁₂)sulfonic ester, haloalkyl(C₁₋₁₂)sulfonic ester, arylsulfonic ester, iminosulfonate, and so on.

These photo-acid generators can be applied singly or in a mixture of two or more kinds thereof. The formulated amount thereof is usually 0.1 to 10 parts by weight, preferably 0.5 to 5.0 parts by weight relative to 100 parts by weight of an alkali-insoluble or slightly alkali-soluble resin.

Further, when an alkali-soluble resin is used in the positive-working chemically amplified radiation sensitive resin composition of the present invention, a dissolution inhibitor is also used together with the alkali-soluble resin. And when an alkali-insoluble or slightly alkali-soluble resin which is protected with an acid dissociable protecting group is used in the chemically amplified positive-working radiation sensitive resin composition of the present invention, a dissolution inhibitor may be also used together therewith, if necessary. The dissolution inhibitor can be exemplified with a phenolic compound, a phenolic hydroxyl group of which is protected with a protecting group being cleavable by the action of acid, for example. The dissolution inhibitor is a compound which is alkali-insoluble or slightly alkali-soluble before a protecting group is cleaved by an acid generated from a photo-acid generator but becomes soluble in an alkali developer, i.e. alkali-soluble, after a protecting group is cleaved. The dissolution inhibitor has a dissolution-inhibiting function to an alkali-soluble resin before a cleavage of a protecting group, however it loses such ability and usually acts as a dissolution accelerator after a cleavage of a protecting group by the action of acid. A group which is cleaved by an action of acid in the dissolution inhibitor can be exemplified with tert-butoxycarbonyl group and so on, which is raised as an acid dissociable protecting group as described above. The concrete examples of the dissolution inhibitor can be exemplified with 2,2-bis(4-tert-butoxycarbonyloxyphenyl)propane, bis(4-tert-butoxycarbonyl-oxyphenyl)sulfone, 3,5-bis(4-tert-butoxycarbonyloxyphenyl)-1,1,3-trimethylindane and so on.

In the positive-working chemically amplified radiation sensitive resin composition of the present invention, a basic compound can be preferably incorporated as an additive. This basic compound is able to control a diffusion phenomenon of an acid generated from a photo-acid generator by an exposure to light in a resist film, and improves resolution or light exposure latitude. These basic compounds can be exemplified with primary, secondary or tertiary aliphatic amines, aromatic amines or heterocyclic amines; nitrogen-containing compounds having an alkyl group, an aryl group, and so on; a compound containing an amide group or an imide group; and so on.

On the other hand, the chemically amplified negative-working radiation sensitive resin composition of the present invention comprises a resin which is alkali-soluble itself, i.e. an alkali-soluble resin, a photo-acid generator, and a crosslinking agent when the alkali-soluble resin is not an acid-responsive self-crosslinkable resin. The irradiated area by radiation of the chemically amplified negative-working radiation sensitive resin composition is made insoluble in an alkali-developer, wherein, by an acid generated from a photo-acid generator, a self-crosslinkable resin is crosslinked or the alkali-soluble resin is crosslinked by a crosslinking agent.

As the alkali-soluble resin and the photo-acid generator used in the above-described negative-working chemically amplified radiation sensitive resin composition, there can be raised the similar alkali-soluble resins and photo-acid generators to ones which were exemplified before in the positive-working chemically amplified radiation sensitive resin composition as a favorable one.

And a crosslinking agent may be a compound which crosslinks and hardens an alkali-soluble resin by the action of acid generated in an area irradiated with radiation. There are raised a various kind of crosslinking agents such as melamines, guanamines, ureas, and so on, but is not limited thereto particularly.

As crosslinking agents, there are exemplified favorably metylolated melamine or alkyletherified compound thereof such as hexamethylol melamine, pentamethylol melamine, tetramethylol melamine, hexamethoxy methylmelamine, pentamethoxy methylmelamine, and tetramethoxy methyl melamine; metylolated benzoguanamine or alkyletherified compounds thereof such as tetramethylol benzoguanamie, tetramethoxy methyl benzoguanamine, and trimethoxy methyl guanamine; N,N-dimethylol urea or dialkyletherified compounds thereof; 3,5-bis(hydroxymethyl)-perhydro-1,3,5-oxadiazine-4-on (dimethyloluron) or alkyletherified compounds thereof; tetramethylol glyoxal diureine and tetramethyl ether compound thereof, 2,6-bis(hydroxymethyl)4-methyl phenol and alkyletherified compounds thereof; 4-tert-butyl-2,6-bis(hydroxy-methyl)phenol and alkyletherified compounds thereof; 5-ethyl-1,3-bis(hydroxymethyl)perhydro-1,3,5-triazine-2-on (N-ethyldimethylol-triazone) or alkyletherified compounds thereof, as fovorable examples.

Further alkoxyalkylated amino resins such as alkoxyalkylated melamine resins or alkoxyalkylated urea resins, for example a methoxymethylated melamine resin, an ethoxymethylated melamine resin, a propoxymethylated melamine resin, a butoxymethylated melamine resin, a methoxymethylated urea resin, an ethoxymethylated urea resin, a propoxymethylated urea resin, a butoxymethylated urea resin, and so on can be also exemplified as favorable ones.

These crosslinking agents can be used singly or in a mixture of two or more kinds thereof and a formulated amount thereof is usually 2 to 50 parts by weight, preferably 5 to 30 parts by weight relative to 100 parts by weight of an alkali-soluble resin.

In the present invention, an alkali-soluble resin, an alkali-insoluble or slightly alkali-soluble resin which is protected with an acid dissociable protecting group, a photo-acid generator, a dissolution inhibitor, a crosslinking agent, additives which are optional components and described below, and so on, which compose the chemically amplified radiation sensitive resin composition, are dissolved in a solvent to be used as a chemically amplified radiation sensitive resin composition. The solvents which are preferably used in the present invention include ethylene glycol monoalkyl ethers such as ethylene glycol monomethyl ether, ethylene glycol monoethyl ether, and so on; ethylene glycol monoalkyl ether acetates such as ethylene glycol monomethyl ether acetate, ethylene glycol monoethyl ether acetate, and so on; propylene glycol monoalkyl ethers such as propylene glycol monomethyl ether, propylene glycol monoethyl ether, and so on; propylene glycol monoalkyl ether acetates such as propylene glycol monomethyl ether acetate, propylene glycol monoethyl ether acetate, and so on; lactic esters such as methyl lactate, ethyl lactate, and so on; aromatic hydrocarbons such as toluene, xylene, and so on; ketones such as methyl ethyl ketone, 2-heptanone, cyclohexanone, and so on; amides such as N,N-dimethylacetamide, N-methylpyrrolidone, and so on; lactones such as γ-butyrolactone and so on; and the like. These solvents can be used singly or in a mixture of two or more kinds thereof.

In the radiation sensitive resin composition of the present invention, there may be incorporated, if necessary, dye staffs, adhesion aids, surfactants, and so on. Examples of the dye staff include Methyl Violet, Crystal Violet, Malakite Green, and so on. Examples of the adhesion aids include hexamethyl disilazane, chloromethyl silane, and so on. And examples of the surfactants include nonionic surfactants such as polyglycols and the derivatives thereof, i.e., polypropylene glycol or polyoxyethylene lauryl ether, and so on; fluorine-containing surfactants such as Fluorad (trade name; product of Sumitomo 3M Co., Ltd.), Megafac (trade name; product of Dai-Nippon Ink & Chemicals, Inc.), Surflon (trade name; product of Asahi Glass Company, Ltd.), organosiloxane surfactants such as KP341 (trade name; product of shin-Etsu Chemical Co., Ltd.), and so on.

In the chemically amplified radiation sensitive resin composition of the present invention, the content of an ultrahigh molecular weight component, the weight average molecular weight of which is one million or more as determined by polystyrene standards when measured by a gel permeation chromatography with a MALS method, is 0.2 ppm or less, preferably 0.02 ppm or less and more preferably 0.002 ppm or less. As described above, in order to prepare the radiation sensitive resin composition of the present invention, as an alkali-soluble resin which is used for preparing a base resin itself or an acid-insoluble or slightly alkali-soluble resin which is protected by an acid dissociable protecting group, it is preferred to use one in which the content of an ultrahigh molecular weight component having one million or more of the weight average molecular weight as determined by polystyrene standards is 1 ppm or less when measured by a gel permeation chromatography (GPC) with a MALS method. It means, when using the resin, wherein the content of an ultrahigh molecular weight component is 1 ppm or less, the radiation sensitive resin composition having 0.2 ppm or less of the content of said ultrahigh molecular weight component in the composition can be obtained directly. And even when the content of said ultrahigh molecular weight component becomes 0.2 ppm or more in the radiation sensitive resin composition, the ultrahigh molecular weight component can be fractionated easily by a simple and short-time treatment by the method such as filtration of the radiation sensitive resin composition, and so on. Therefore it becomes possible easily to control the content of an ultrahigh molecular weight component 0.2 ppm or less in the composition. As for the composition obtained in this way, the content of an ultrahigh molecular weight component is confirmed to be 0.2 ppm or less in the composition when measured by a gel permeation chromatography (GPC) with a MALS method. Then composition satisfying the determined amount is selected from the radiation sensitive resin composition confirmed and the selected composition is used as the radiation sensitive resin composition of the present invention. When using as a base resin the resin having the content of above described ultrahigh molecular weight component of 1 ppm or less in the resin, it is often required to control the content of above described ultrahigh molecular weight component in the composition as becoming under 0.2 ppm at the stage where a composition was prepared. However in that case the aforementioned ultrahigh molecular weight component in the obtained radiation sensitive resin composition may be also separated utilizing a filtrating separation method and so on to control the content of aforementioned ultrahigh molecular weight component in the composition in the determined limit and to be selected.

By the way, an alkali-soluble resin, an alkali-insoluble or slightly alkali-soluble resin which is protected with an acid dissociable protecting group, a photo-acid generator, a dissolution inhibitor, a crosslinking agent, an additive which is an optional component, and so on can be referred to the literatures exemplified with as prior art and so on, if further necessary. In the present invention, the content of an ultrahigh molecular weight component of a base resin in the positive-working or negative-working chemically amplified radiation sensitive resin composition, the weight average molecular weight of which is one million or more as determined by polystyrene standards, may be 0.2 ppm or less in the composition when measured by a gel permeation chromatography with a multi angle laser light scattering method. When this condition is fulfilled, any known alkali-soluble resin and alkali-insoluble or slightly alkali-soluble resin which is protected with an acid dissociable protecting group can be used as long as it is an alkali-soluble resin without distinction of species of resin. And said composition may be any compositions for irradiation light source selected from the group consisting of ultra violet light, deep ultra violet light such as KrF excimer laser, ArF excimer laser, F₂ excimer laser, and so on, X rays or electron beams.

In the following, one example of processes for producing semiconductor is further explained in details referring to drawings using the chemically amplified radiation resin composition of the present invention and using KrF excimer laser as a light source of exposure.

In FIG. 1, using the positive-working chemically amplified radiation resin composition of the present invention, a method of forming a grooved resist pattern of concavity shape on an object to be processed on a substrate is shown. First, an object to be processed 2 of an electrically conductive film such as a polycrystalline silicon film or of an insulating film such as a silicon oxide film and so on is formed on a silicon semiconductor substrate such as a silicon wafer 1. The chemically amplified positive-working radiation resin composition of the present invention is applied by spin-coating on this object to be processed, and then prebaked, if necessary (for example, at baking temperature of 70° C. to 150° C. and approximately for one minute) and a photoresist film 3 is formed on the object to be processed (see: FIG. 1(a)). Next, although not shown in the drawing, a pattern-wise light exposure is conducted through a mask for a light exposure like a reticle on a photoresist film 3 using KrF excimer laser as a light source of exposure. After exposure to light, a post exposure bake (PEB) is conducted if necessary (baking temperature is at 50° C. to 150° C., for example.). Then the development and bake after the development (baking temperature at 60° C. to 120° C., for example), if necessary, are conducted and a resist mask 4 having a grooved pattern 4a is formed (see: FIG. 1(b)). And then the object to be processed 2 is dry-etched through a resist mask 4, a groove 5 of 0.2 μm or less in width, in this case 0.15 μm in width, copying a grooved pattern 4a is formed (see: FIG. 1(c)).

In FIG. 2, a method of forming a gate electrode on an object to be processed is shown as a convexity shaped pattern. First, a gate dielectric film 11 consisting of a thin silicon oxide film is formed on a silicon semiconductor substrate 1. After forming a polycrystalline silicon film 12 which is an object to be processed, the negative-working chemically amplified radiation resin composition of the present invention described above is applied by spin-coating on this polycrystalline silicon film 12 and prebaked if necessary to form a negative-working photoresist film 13 (see: FIG. 2(a)). Next, development is conducted after exposure to light through a mask, PEB is then conducted, if necessary to form a resist mask 14 with an electrode shape (see: FIG. 2(b)). Further dry-etching of a polycrystalline silicon film 12 and a gate dielectric film 11 is conducted through this resist mask 14 to form a gate electrode 15 with 0.2 μm or less long of gate length, 0.15 μm long in this case, copying a shape of the resist mask 14 (see: FIG. 2(c)). In the case of a MOS transistor, following to the resist mask being removed by ashing treatment and so on, implantation of impurity ion is conducted to form a source and drain region 16 (see: FIG. 2(d)). When this gate electrode is formed, gate electrode wiring to energize on the gate electrode may be formed at the same time when this gate electrode is formed.

In the examples described above, a spin-coating method was applied as a coating method of the radiation sensitive resin composition. However an application of the radiation sensitive resin composition is not limited to the aforementioned spin-coating method. And any coating method so far publicly known can be applied such as a roll coat method, a land coat method, a flow spreading coat method, a dip coat method, and so on. Although a silicon film or an silicon oxide film were exemplified as an object to be processed 2, other films used in a semiconductor device such as a metal film such as aluminum, molybdenum, chromium, an oxidized metal film such as ITO, an dielectric film such as phosphorus silicate glass (PSG) can be an object to be processed. The silicon film is not limited to a polycrystalline silicon film. It may be an amorphous silicon film or a single crystal silicon film and the silicon film may further include impurity ions. Further in the process for producing a semiconductor device of the present invention, a formation of resist pattern is not limited to the above-described examples and any publicly known photography method can be applied. A radiation source to be used for an exposure to light can include deep ultra violet light such ArF excimer laser, F₂ excimer laser and so on, besides KrF excimer laser, ultra violet light, X-rays, electron beams, and so on. A mask to be used, a light exposure method, a developing method, a developer, a prebaking condition, a PEB condition, and so on, can be the method or the material so far publicly known. And an etching method can be a wet etching method instead of the above-described dry-etching method, a semiconductor device producing process can be also any process so far publicly known. The chemically amplified positive-working radiation sensitive resin composition of the present invention can be applied for an etching resist, ion implantation mask, and so on of all parts, for which a photolithographic technology is applied in the formation of a semiconductor device and therefore by the process for producing a semiconductor device of the present invention, a various kind of parts of a semiconductor device such as a source or drain region of a semiconductor, a gate electrode, a contact hole of a source or drain electrode, a trench, metal wiring, and so on can be formed. Therefore the formed resist pattern can be not only thin line shape of above described concavity shape or convexity shape, but also optionally desired shaped pattern such as planar of concavity shape or convexity shape, hole shape, and so on and further may be a wiring shape when forming a metal wiring.

### BEST MODE FOR PRACTICING THE INVENTION

The present invention will now be described more specifically by reference to Examples, which, however, are not to be construed to limit the present invention in any way.

### EXAMPLE 1

Measurement of an Amount of an Ultrahigh Molecular Weight Component in a Resin by a Multi Angle Laser Light Scattering Detector

5.00 g of polyhydroxystyrene (hereafter called “PHS”) was dissolved in dimethylformamide (hereafter called “DMF”) to make the solution 100 g. This PHS of 5 wt % solution in DMF was separated according to the molecular weight by GPC (gel permeation chromatography) using 5 mmol/L of lithium bromide dissolved in DMF as an eluant, and an ultrahigh molecular weight component in the PHS was detected by a multi angle laser light scattering detector. The peak area thereof was determined and then the concentration is calculated by comparing with the area of polystyrene standards.

The method wherein a separation is conducted according to the molecular weight by GPC, an ultrahigh molecular weight component was detected and the concentration is calculated may be simply called “MALS method” in the description below.

Preparation of a Raw Material Resin

PHS containing 50 ppm of an ultrahigh molecular weight component was made one containing 1 ppm of an ultrahigh molecular weight component by applying a filtrating separation method usually applied to be prepared as a raw material.

Preparation of a Radiation Sensitive Resin Composition

The above described PHS was used as a raw material, and a hydroxyl group in the PHS was partially protected with ethylvinyl ether by using camphor sulfonic acid as a catalyst followed by further partially protecting the reacted PHS with di-t-butyldicarbonate using dimethylaminopyridine as a catalyst to prepare poly[p-(1-ethoxyethoxy)styrene-p-t-butoxycarbonyl-p-hydroxystyrene]. After the product was confirmed to contain 3 ppm or less of an ultrahigh molecular weight component by a MALS method, relative to 100 g of the solid content of the product, 0.567 g of triphenyl sulfonyl triflate, 3.0 g of biscyclohexylsulfonyl diazomethane and 7.9 g of triphenyl sulfonium acetate (TPSA) PGMEA solution in which 0.1 mmol/g of TPSA was contains, 0.04 g of dicyclohexylmethyl amine, 4.0 g of N,N-dimethylacetoamide, and 0.06 g of Megafac (trade name: an improving agent for film formation and affinity with a substrate upon applying a resist) were mixed and the solid content ratio thereof was controlled to 12% using propylene glycol monomethyl ether acetate (PGMEA) to obtain a radiation sensitive resin composition. This composition was separated by filtration until the content of an ultrahigh molecular weight component was confirmed to become 0.2 ppm or less by a MALS method and prepared.

Measurement of an Amount of an Ultrahigh Molecular Weight Component in a Radiation Sensitive Resin Composition (Concentrated MALS Method)

After filtrating 200 g of the radiation sensitive resin composition A obtained by the above description with a filter made of an ultrahigh molecular weight polyethylene and having diameter of 47 mm and pore size of 0.05 μm, the filter was immersed in 5 g of DMF to make a sample solution. This solution was measured in the same manner as the above-described “Measurement of an amount of an ultrahigh molecular weight component in a resin by a multi angle laser light scattering detector” and an amount of an ultrahigh molecular weight component in the radiation sensitive resin composition was obtained. At this time, it was calculated with a collection efficiency of an ultrahigh molecular weight component by filtration as 10%. The obtained amount of an ultrahigh molecular weight component was 0.2 ppm.

In the above description, the measurement of GPC was conducted using Millennium System (999 pump, 410RI detector, 700 auto-sampler, analyzing software (name of software: Millennium) mounted computer) of Waters Inc. as a device and connecting two pieces of Shodex KD-806M (product of Showa Denko K.K.) in series as a column.

The measurement by a multi angle laser light scattering detector was conducted using DAWN EOS of Wyatt Technology Inc. as a detector.

Formation of a Resist Image

The radiation sensitive resin composition having 0.2 ppm of the amount of an ultrahigh molecular weight component described above was applied by spin-coating on a polysilicon wafer which was a substrate of semiconductor, was baked on a direct hot plate at 90° C. for 90 seconds to form a photoresist film having the film thickness of 0.450 μm. Further a water-soluble organic film was applied onto the photoresist film to form a film with the film thickness of 44 nm as an anti-reflective coating. This resist film was selectively exposed to light by KrF excimer laser light of 248.4 nm through a half tone phase shift mask followed by conducting post exposure bake (PEB) on a direct hot plate at 120° C. for 90 seconds and then a paddle development with an alkali developer (2.38 weight % tetramethylammonium hydroxide (TMAH) aqueous solution) for 60 seconds to obtain a trench pattern on the polysilicon wafer.

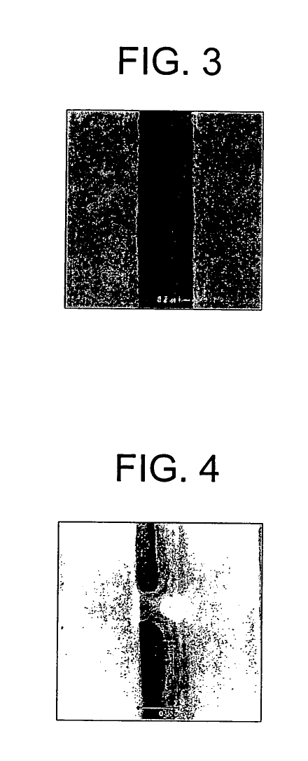

The size of the obtained trench pattern was formed to be 160 nm by making smaller than a mask size by selecting a quantity of exposure light (that is, “making a bias”). The number of defects in a 160 nm-trench pattern on a substrate was counted using a surface defect inspector (KLA-2115 or KLA-2135 of KLA Tencole Company, for example) and 500 pieces on an 8 inch-substrate which was good result was obtained. On the other hand, in 180 nm-trench pattern formed by altering a quantity of exposure light, no defects were observed. SEM (Scanning Electronic Microscope) photograph of a pattern of grooved shape having no defects at this time was shown in FIG. 3 and also SEM photograph of a micro bridge which was recognized as a pattern defect was shown in FIG. 4.

### COMPARATIVE EXAMPLE 1

Preparation of a Radiation Sensitive Resin Composition

Using PHS having 50 ppm of an amount of an ultrahigh molecular weight component as it is, a hydroxyl group of the PHS was protected with ethylvinyl ether using camphor sulfonic acid as a catalyst followed by being further protected with di-t-butyldicarbonate using dimethylaminopyridine as a catalyst to obtain poly[p-(1-ethoxyethoxy)styrene-p-t-butoxycarbonyl-p-hydroxystyrene]. This polymer was used as a composition material, and the same manner was taken as the Example 1 except for conducting no separation treatment by filtrating to prepare a radiation sensitive resin composition B.

Measurement of an Amount of an Ultrahigh Molecular Weight Component in a Radiation Sensitive Resin Composition The amount of an ultrahigh molecular weight component in the radiation sensitive resin composition B was measured in the same manner as the Example 1 by a multi angle laser light scattering detector and the value was 2 ppm.

Formation of a Resist Image

The radiation sensitive resin composition having 2 ppm of the amount of an ultrahigh molecular weight component described above was applied by spin-coating on a polysilicon wafer which was a substrate of semiconductor and then baked on a direct hot plate at 90° C. for 90 seconds to form a photoresist film having the film thickness of 0.450 μm. Further a water-soluble organic film was applied on this photoresist film to form a film with the film thickness of 44 μm as an anti-reflective coating. This resist film was selectively exposed to light by KrF excimer laser light of 248.4 nm through a half tone phase shift mask, followed by conducting post exposure bake (PEB) on a direct hot plate at 120° C. for 90 seconds and a paddle development with an alkali developer (2.38 weight-% tetramethylammonium hydroxide (TMAH) aqueous solution) for 60 seconds to obtain a trench pattern on the polysilicon wafer.

The size of the obtained trench pattern was formed to be 160 nm by making smaller than a mask size by selecting a quantity of exposure light (that is, “making a bias”). The number of defects in a 160 nm-trench pattern on a substrate was counted using the surface defect inspector and 7000 pieces on an 8 inch-substrate was observed. When the size of trench pattern was made 180 nm, the number of this defect was decreased to 100 pieces.

### EXAMPLE 2

The same manner was taken as Example 1 except for using PHS having 9 ppm of an ultrahigh molecular weight component as the raw material PHS of poly[p-(1-ethoxyethoxy)styrene-p-t-butoxycarbonyl-p-hydroxystyrene] to obtain a radiation sensitive resin composition C. The amount of an ultrahigh molecular weight component of the obtained composition C in the composition was 0.1 ppm. Using this composition C, a resist image formation and a measurement of defect number in the 160 nm-trench pattern were conducted in the same manner as Example 1. The results were shown in Table 1.

### COMPARATIVE EXAMPLE 2

The same manner was taken as Comparative Example 1 except for using PHS having 9 ppm of an ultrahigh molecular weight component as the raw material PHS of poly[p-(1-ethoxyethoxy)styrene-p-t-butoxycarbonyl-p-hydroxystyrene] to obtain a radiation sensitive resin composition D. The amount of an ultrahigh molecular weight component of the obtained composition D in the composition was 1 ppm. Using this composition D, a resist image formation and a measurement of defect number in the 160 nm-trench pattern were conducted in the same manner as Example 1. The results were shown in Table 1.

### EXAMPLE 3

The same manner was taken as Example 1 except for using PHS having 0.2 ppm of an ultrahigh molecular weight component in the resin as the raw material PHS of poly[p-(1-ethoxyethoxy)styrene-p-t-butoxycarbonyl-p-hydroxystyrene] to obtain a radiation sensitive resin composition E. The amount of an ultrahigh molecular weight component of the obtained composition E in the composition was 0.01 ppm. Using this composition E, a resist image formation and a measurement of defect number in the 160 nm-trench pattern were conducted in the same manner as Example 1. The results were shown in Table 1.

### EXAMPLE 4

The same manner was taken as Example 1 except for using poly[p-(1-ethoxyethoxy)styrene-p-t-butoxycarbonyl-p-hydroxystyrene], which was prepared by using PHS having 0.2 ppm of an amount of an ultrahigh molecular weight component as a raw material and treating the obtained composition using a filtrating separation method as the amount of an ultrahigh molecular weight component in the composition becomes 0.02 ppm by MALS method, to obtain a radiation sensitive resin composition F. Using the composition F, a resist image formation and a measurement of defect number in the 160 nm-trench pattern were conducted in the same manner as Example 1. The results were shown in Table 1.

### EXAMPLE 5

The radiation sensitive resin composition G was prepared by treating the radiation sensitive resin composition B of Comparative Example 1 by a filtrating separation method until the amount of an ultrahigh molecular weight component was confirmed to 1 ppm or less. The amount of an ultrahigh molecular weight component of the composition G in the composition was 0.1 ppm. Using this composition G, a resist image formation and a measurement of defect number in the 160 nm-trench pattern were conducted in the same manner as Example 1. The results were shown in Table-1.

TABLE 1

| | | | Number | |
|---|---|---|---|---|
| | PHS, Amount of | Radiation | of | with or |
| | ultrahigh | sensitive resin | defects | without |
| | molecular weight | composition, | (pieces/ | PHS |
| | component (ppm) | AUHMW* (ppm) | wafer) | treatment |
| Example 1 | 50 | 0.2 | 500 | with |
| Example 2 | 9 | 0.1 | 250 | with |
| Comparative | 50 | 2 | 7000 | without |
| Example 1 | | | | |
| Comparative | 9 | 1 | 4000 | without |
| Example 2 | | | | |
| Example 3 | 0.2 | 0.01 | 5 | with |
| Example 4 | 0.2 | 0.02 | 10 | without |
| Example 5 | 50 | 0.1 | 300 | without |

*AUHMW; amount of an ultrahigh molecular weight component

From the above description, it was figured out that defects such as a micro bridge and so on can be drastically decreased when forming a 180 nm, 160 nm or less size of trench pattern in the chemically amplified radiation sensitive resin composition of the present invention.

### EFFECTS OF INVENTION

As described above in details, the chemically amplified radiation sensitive resin composition having high sensitivity and high resolution, being excellent in a pattern form and having less defects and the process for producing thereof can be proposed according to the present invention. By this, a pattern formation can be realized in accordance with a design rule with high accuracy and high throughput in the fine processing for manufacturing the three-dimensional micro structural articles or electronic parts such as a semiconductor.

### INDUSTRIAL APPLICABILITY

The chemically amplified radiation sensitive resin composition of the present invention can be preferably used as a photoresist upon manufacturing electronic parts such as a semiconductor and three-dimensional micro structural articles such as a micro-machine.

1. A chemically amplified radiation sensitive resin composition comprising at least (1) a base resin that is an alkali-soluble resin or an alkali-insoluble or slightly alkali-soluble resin protected by an acid dissociable protecting group, (2) a photo-acid generator that generates an acid by irradiation of radiation and (3) a solvent,
wherein an amount of an ultrahigh molecular weight component whose weight average molecular weight is one million or more determined by polystyrene standards, of the alkali-soluble resin or the alkali insoluble or slightly alkali-soluble resin protected by an acid dissociable protecting group is 0.2 ppm or less in the composition when measured by a gel permeation chromatography with a multi angle laser light scattering method.

2. A chemically amplified radiation sensitive resin composition according to claim 1, wherein, the base resin or a raw material alkali-soluble resin before being protected by the acid dissociable protecting group is one in which an amount of an ultrahigh molecular weight component whose weight average molecular weight is one million or more determined by polystyrene standards, is 1 ppm or less in the resin components when measured by a gel permeation chromatography with a multi angle laser light scattering method.

3. A process for producing a chemically amplified radiation sensitive resin composition according to claim 1 or 2, comprising a step of measuring an amount of an ultrahigh molecular weight component whose weight average molecular weight is one million or more as determined by polystyrene standards, by a gel permeation chromatography with a multi angle laser light scattering method and removing the component.

4. A process for producing a semiconductor device, comprising the steps of:
applying a chemically amplified radiation sensitive resin composition on an object to be processed to form a photoresist film and then processing the photoresist film into a desired shape; and
etching the object to be processed by using as a mask a photoresist pattern obtained in the above step,
wherein a chemically amplified radiation sensitive resin composition that forms the photoresist film comprises at least (1) a base resin that is an alkali-soluble resin or an alkali-insoluble or slightly alkali-soluble resin protected by an acid dissociable protecting group, (2) a photo-acid generator that generates an acid by irradiation of radiation, and (3) a solvent and an amount of an ultrahigh molecular weight component of the alkali-soluble resin or the alkali-insoluble or slightly alkali-soluble resin protected by an acid dissociable protecting group whose weight average molecular weight is one million or more determined by polystyrene standards, is 0.2 ppm or less in the composition when measured by a gel permeation chromatography with a multiple light scattering method.

5. A process for producing a semiconductor device according to claim 4, wherein the base resin or a raw material alkali-soluble resin before being protected by the acid dissociable protecting group of the chemically amplified radiation sensitive resin composition is one in which an content of an ultrahigh molecular weight component whose weight average molecular weight is one million or more determined by polystyrene standards, is 1 ppm or less in the resin components when measured by a gel permeation chromatography with a multiple light scattering method.
